(19) United States
(12) Patent Application Publication
(10) Pub. No.: US 2008/0065987 A1
(43) Pub. Date: Mar. 13, 2008

(54) INTEGRATION OF VISUAL CONTENT RELATED TO MEDIA PLAYBACK INTO NON-MEDIA-PLAYBACK PROCESSING

(76) Inventors: Jesse Boettcher, San Jose, CA (US); Sandeep Gupta, Fremont, CA (US)

Correspondence Address: BEYER WEAVER LLP/APPLE INC., P.O. BOX 70250, OAKLAND, CA, 94612-0250, US

(21) Appl. No.: 11/530,767

(22) Filed: Sep. 11, 2006

(51) Int. Cl. G06F 3/00

(52) U.S. Cl. 715/704

(57) ABSTRACT

In accordance with an aspect, a method is provided to operate a portable electronic device including integrated operation of media playback processing with non-media-playback processing. A collection of information related to media playback processing may be maintained. The non-media-playback processing may be operated to include customizing the non-media-playback processing based on information, from the maintained collection information, corresponding to then-current operation of the media playback processing.

### BACKGROUND

Portable electronic devices for media playback have been popular and are becoming ever more popular. For example, a very popular portable media player is the line of iPod® media players from Apple Computer, Inc. of Cupertino, Calif. In addition to media playback, the iPod® media players also provide game playing capabilities.

### SUMMARY

The inventors have realized that it is desirable to create an integrated media playback and non-media playback (such as game playing) experience.

Methods are provided to operate a portable electronic device including integrated operation of media playback processing with non-media-playback processing. A collection of information related to media playback processing can be maintained. The non-media-playback processing can be operated to include customizing the non-media-playback processing based on information, from the maintained collection information, corresponding to then-current operation of the media playback processing.

### BRIEF DESCRIPTION OF THE DRAWINGS

FIG. 1 is an architecture diagram broadly illustrating an example of processing within an electronic device such as a portable media player, wherein a media playback application is executing to playback audio media at the same time as a non-media-playback application (here, a game application) is executing.

FIG. 2 is a flowchart that illustrates processing steps for an example of integrating the associated media visual information into a game visual presentation.

### DETAILED DESCRIPTION

A method is described to integrate visual content related to media playback into non-media-playback processing occurring at the same time as the media playback, such as games.

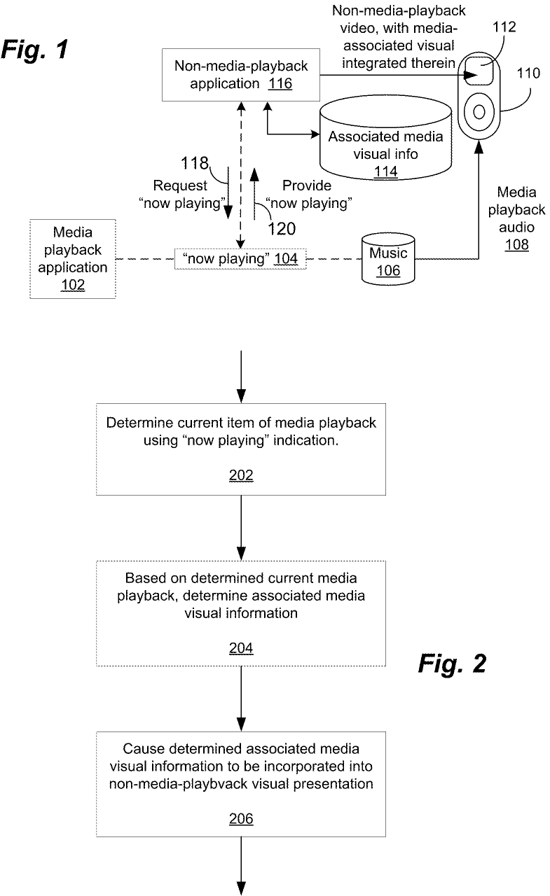

FIG. 1 is an architecture diagram broadly illustrating an example of processing within an electronic device such as a portable media player, wherein a media playback application is executing to playback audio media, at least when considered at a macroscopic level, at the same time as a non-media-playback application (such as a game application) is executing. That is, while perhaps at some level of machine instruction resolution, the processes may appear to be executing not at the same time (e.g., processes may be threaded), when viewed at a higher level, the processing is executing at the same time.

Referring specifically to FIG. 1, the media playback application 102 can operate to cause audio 108 to be played back to a user via a portable media player 110. Such playback can be based at least in part on user input to the portable media player 110. In the FIG. 1 example, the media playback audio can be provided from a music storage 106 which may be storage closely associated with the portable media player 110 (such as being housed within a housing of the portable media player 110). In general, the media playback audio can be nominally generated in a predictive manner and, while user interaction may affect the media playback audio (e.g., by a user activating a “fast forward” or other user interface item), the media playback audio is nominally generated in a predictive manner. The media playback application 102 maintains a “now playing” indication 104, which can provide an indication of the content of the media playback audio 108.

Meanwhile the game application 116 may operate to, among other things, provide game video to a display 112 of the portable media player 110. The game application 116 is an example of non-media-playback processing. That is, the game video provided to the display 112 of the portable media player 110 is typically, at least in part, responsive to game-playing actions of a user of the portable media player 110. In this respect, the game video is not nominally generated in a predictive manner, as is the case with media playback processing. The game application 116 operates while media playback audio 108 is being played back to the user.

As part of the game application 116 processing, the game application 116 may provide a request 118 for the “now playing” indication 104, and a reply 120 provides the value of the “now playing” indication 104 back to the game application 116. This request 118 and reply 120 may be as simple as merely querying a register (e.g., using a particular API) or may include a more sophisticated protocol for obtaining the “now playing” indication 104.

Using the “now playing” indication 104, the game application 116 processing retrieves particular associated media visual information 114. For example, the particular associated media visual information 114 may be album cover art work provided by a publisher of the media being played back. The particular associated media visual information 114 may be visual information associated by the user with the media being played back, such as a photograph taken or otherwise obtained by the user and associated with the media being played back.

The game application 116 can cause the particular associated media visual information to be integrated into visual content of the game. As just one example, the game may include cityscape visual content, and album cover art work associated with music being played back by the media playback application 102 may be caused to be displayed on a billboard of the cityscape. Visually, the particular associated media visual information appears to a user to be part of the visual content of the game.

In many instances, the particular associated media visual information is readily available, such as being in an artwork cache for images. Thus, for example, a more computationally expensive retrieval of the particular associated media visual information can be avoided or minimized, such as retrieving the particular associated media from a disk that must be initially spun up to be accessed.

While the description above has been with respect to particular associated media visual information, in some examples, there is other metadata available regarding the media playback audio 108, and that metadata may be used by the game application 116 as a basis to modify or otherwise process or generate the game video provided to the display 112.

FIG. 2 is a flowchart that illustrates processing steps for an example of integrating the associated media visual information into a game visual presentation. At step 202, the current item of media playback is determined using the “now playing” indication. At step 204, based on the determined current item of media playback, associated media visual information is determined. At step 206, the determined associated media visual information is caused to be integrated into the game visual presentation.

In some examples, a visual game presentation employs media visual information beyond that associated with a current item of media playback. For example, the media visual information employed may be with respect to other media in a media library of the electronic device. As one example, the game may include providing a trivia question based on information in the media library.

We have described how visual content related to media playback may be integrated into non-media-playback processing occurring at the same time as the media playback, such as games. While games have been discussed as examples of non-media-playback processing, the non-media-playback processing may include other than games.

The following applications are incorporated herein by reference in their entirety: U.S. Pat. No. ______, filed concurrently herewith, entitled “TECHNIQUES FOR INTERACTIVE INPUT TO PORTABLE ELECTRONIC DEVICES,” (Atty Docket No. APL1P486/P4322US1); and U.S. Pat. No. ______, filed concurrently herewith, entitled “ALLOWING MEDIA AND GAMING ENVIRONMENTS TO EFFECTIVELY INTERACT AND/OR AFFECT EACH OTHER,” (Atty Docket No. APL1P487/P4323US1).

What is claimed is:

1. A method of operating an electronic device including integrated operation of media playback processing with non-media-playback processing, the method comprising:
operating the media playback processing;
maintaining a collection of information related to media playback processing; and
operating the non-media-playback processing at the same time as the media playback processing, including customizing the non-media-playback processing based on information, from the maintained collection information, corresponding to then-current operation of the media playback processing.

2. The method of claim 1, wherein:
the collection of information related to media playback processing is visual information.

3. The method of claim 1, wherein:
the media playback processing includes playback of audio media; and
the collection of information related to media playback processing is visual information corresponding to the audio media.

4. The method of claim 3, wherein:
the visual information corresponding to the audio media is artwork corresponding to the audio media.

5. The method of claim 1, wherein:
the media playback processing includes playback of audio media; and
the collection of information related to media playback processing is metadata information corresponding to the audio media.

6. The method of claim 5, wherein:
customizing the non-media-playback processing based on information, from the maintained collection information, corresponding to then-current operation of the media playback processing includes
processing the metadata information corresponding to the audio media currently being played back; and
based at least in part on processing the metadata information, customizing the non-media-playback processing to include visual information corresponding to the audio media currently being played.

7. A computer program product to operate an electronic device including integrated operation of media playback processing and non-media-playback processing, the computer program product comprising at least one computer-readable medium having computer program instructions stored therein which are operable to cause at least one computing device of the electronic device to:
operate the media playback processing;
maintain a collection of information related to media playback processing; and
operate the non-media-playback processing at the same time as the media playback processing, including customizing the non-media-playback processing based on information, from the maintained collection information, corresponding to then-current operation of the media playback processing.

8. The computer program product of claim 7, wherein:
the collection of information related to media playback processing is visual information.

9. The computer program product of claim 7, wherein:
the media playback processing includes playback of audio media; and
the collection of information related to media playback processing is visual information corresponding to the audio media.

10. The computer program product of claim 9, wherein:
the visual information corresponding to the audio media is artwork corresponding to the audio media.

11. The computer program product of claim 7, wherein:
the media playback processing includes playback of audio media; and
the collection of information related to media playback processing is metadata information corresponding to the audio media.

12. The computer program product of claim 11, wherein:
customizing the non-media-playback processing based on information, from the maintained collection information, corresponding to then-current operation of the media playback processing includes
processing the metadata information corresponding to the audio media currently being played back; and
based at least in part on processing the metadata information, customizing the non-media-playback processing to include visual information corresponding to the audio media currently being played.

13. An electronic device configurable for integrated operation of media playback processing with non-media-playback processing, the device comprising:
circuitry configurable to operate the media playback processing;
circuitry configurable to maintain a collection of information related to media playback processing; and
circuitry configurable to operate the non-media-playback processing at the same time as the media playback processing, including customizing the non-media-playback processing based on information, from the maintained collection information, corresponding to then-current operation of the media playback processing.

14. An electronic device configurable for integrated operation of media playback processing with non-media-playback processing, the device comprising:
processing circuitry configured to operate the media playback processing and, at the same time, operate the non-media-playback processing; and
storage circuitry, wherein the processing circuitry is configured to maintain a collection of information related to the media playback processing,
wherein the non-media-playback processing is customized based on information, from the maintained collection information, corresponding to then-current operation of the media playback processing.

15. The electronic device of claim 14, wherein:
the collection of information related to media playback processing is visual information.

16. The electronic device of claim 14, wherein:
the media playback processing includes playback of audio media; and
the collection of information related to media playback processing is visual information corresponding to the audio media.

17. The electronic device of claim 16, wherein:
the visual information corresponding to the audio media is artwork corresponding to the audio media.

18. The electronic device of claim 14, wherein:
the media playback processing includes playback of audio media; and
the collection of information related to media playback processing is metadata information corresponding to the audio media.

19. The electronic device of claim 18, wherein:
customizing the non-media-playback processing based on information, from the maintained collection information, corresponding to then-current operation of the media playback processing includes
processing the metadata information corresponding to the audio media currently being played back; and
based at least in part on processing the metadata information, customizing the non-media-playback processing to include visual information corresponding to the audio media currently being played.
